(19) United States
(12) Patent Application Publication
(10) Pub. No.: US 2026/0087814 A1
(43) Pub. Date: Mar. 26, 2026

(54) SYSTEM AND METHOD TO TAG A PERSON IN A VIDEO WITH AN ACTION AND TO PROVIDE AN AUDIBLE DESCRIPTION THEREOF

(71) Applicant: MOTOROLA SOLUTIONS, INC., CHICAGO, IL (US)

(72) Inventors: SOON HOE LIM, IPOH (MY); SU SIEW SOH, SUGAI ARA (MY); MARGARET LEE HING CHOO, BANDAR BARU AIR ITAM (MY); KUANG ENG LIM, SUNGAI JAWI (MY)

(21) Appl. No.: 18/897,094

(22) Filed: Sep. 26, 2024

(51) Int. Cl. G06V 20/52; G06Q 50/26; G06V 10/70; G06V 10/94; G06V 20/40; G08B 3/00

(52) U.S. Cl. CPC G06V 20/52; G06Q 50/265; G06V 10/70; G06V 10/945; G06V 20/40; G08B 3/00

(57) ABSTRACT

Techniques for tagging a person in a video with an action and to provide an audible description thereof are provided. A video stream including at least one person is displayed to a user. An indication is received from the user to tag the at least one person. The indication includes an action to associate with the at least one person. An audible description of the at least one person is generated. An audible description of the action is generated. The audible description of the at least one person and the audible description of the action is broadcast.

### BACKGROUND

In the field of public safety, one of the most critical tools is mission critical communications provided by Land Mobile Radio (LMR) systems such as Project 25 and TETRA systems. Over the years LMR systems have become highly reliable and allow for voice communications in circumstances where other forms of communication (e.g. cellular telephones, Wi-Fi, etc.) are unavailable. Thus, LMR systems ensure that mission critical voice communication is always available to public safety first responders.

As time has passed, video cameras have become ubiquitous. It has been said that it is very likely that every time a person leaves their house, they are captured on at least one video camera (e.g. public safety cameras, store surveillance cameras, building surveillance cameras, etc.). Thus, the use of video can be highly beneficial in the context of responding to public safety incidents. The use of video cameras may allow public safety responders to get a better view of the incident location.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIGS. 1A-C depict examples of tagging a person in a video with an action and to provide an audible description thereof according to the techniques described herein.

FIG. 2 is an example of a flow chart that may represent an implementation of the tagging and audible description generation techniques described herein.

FIG. 3 is an example of a device that may implement the tagging and audible description generation techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As mentioned above, LMR communications has evolved to be a very reliable technique for transmitting voice and limited amounts of data to a public safety first responder in the field. Unfortunately, most current LMR devices do not include the capability to display video, or in many cases, even still images. This is generally because the devices are optimized to provide reliable, clear, voice communications with a potential for some limited data transmissions (e.g. text messages, etc.).

A problem arises when an incident occurs that is captured using a camera, either video or still, and information and instructions need to be conveyed from a viewer of the images generated by the camera and a public safety first responder in the field. The entity viewing the video would need to describe what might be a suspect in the video. For example, consider a case where video is being monitored at a Real Time Crime Center (RTCC). An RTCC may receive video from any number of video sources (e.g. public safety cameras, enterprise cameras, retail cameras, private cameras, etc.). An RTCC analyst or Artificial Intelligence bot may monitor these video feeds to detect incidents.

When an incident is detected, a person may be identified (e.g. a suspect). For example, consider a case where the video is of pedestrians on a street, and one of the people assaulted another person. An RTCC analyst may then convey the person's description, via audio over LMR, to a first responder in the field. For example, the analyst may specific that the person is wearing a red shirt, blue pants, white shoes, and a green hat. As should be clear, the description could be problematic, as each analyst may describe the person differently. For example, one analyst may say the shirt is red, while another may interpret the shirt as maroon.

In addition, the person's appearance may change at some time. In the preceding example, the suspect was originally described as wearing a hat. However, at some point, the suspect may remove the hat. If the analyst does not notice this change in appearance of the suspect and update the description, the first responder in the field may still be looking for a suspect in a hat, which is no longer an accurate description.

The analyst may also wish to indicate that a certain action with respect to the suspect be taken. In the present example, it may be desired to capture the suspect. The analyst would then need to communicate the action to be taken audibly over the LMR radio. As should be clear, this process may be time consuming and subject to errors.

The techniques described herein overcome these problems individually and collectively. A viewer of a video may view the video on a device that is capable of receiving input. One example of such a device may be a device with a touch screen, such as a smartphone or tablet.

Other devices could include a laptop or computer with a touch screen interface. Yet other example devices could include a screen associated with other forms of input (e.g. touchpad, trackpoint, mouse, stylus, etc.). What should be understood is that regardless of the particular device, a person being displayed on the screen can be marked with a shape. The techniques described herein may associate a shape with a particular action. For example, a star shape may indicate that the suspect is to be captured.

In operation, a user, such as a commander or analyst who is able to view the video may determine that a person in the video should be brought to the attention of field public safety responders. The user, using the input mechanism of the device, may mark the person. For example, the user may draw a star shape on top of the person of interest. Drawing a star shape on the person of interest causes an artificial intelligence (AI) bot to process the image of the person marked so marked. The AI bot may then generate a description of the person of interest. Because the description is generated by an AI bot, the problems with differences in description by different humans is avoided.

As mentioned above, the star shape may indicate the person of interest is to be captured. Other shapes may indicate other actions or descriptions. For example, a circle shape may indicate the person of interest should be monitored, while a triangle symbol may indicate the person of interest should be considered armed and/or dangerous.

The AI bot may then convert the description of the person of interest into an audible format using any number of known text to speech conversion techniques. In addition, the action may also be converted to an audible format. Both the audible description and the audible action can then be sent to the first responder via a LMR.

In addition, the AI bot may continue to monitor the video to detect any changes in the appearance of the person of interest that has been marked with the shape. For example, if the person was wearing a hat, but has now removed the hat, the description of the person of interest can be updated. This updated description can again be converted to an audible format. The updated audible description may then be sent to the first responder via LMR. As should be clear, the techniques described herein provide an intuitive way for a person of interest in a video to be indicated by drawing a shape on the person. The shape indicates an action to be taken with respect to the person of interest. The description of the person of interest is generated in a consistent format by an AI bot and the description as well as the desired action is audibly sent to a first responder in the field who is using a device that may not be capable of receiving video. Any further changes of appearance of the person of interest will be tracked and updated audible descriptions are provided to the first responder.

A method is provided. The method includes displaying, to a user, a video stream, the video stream including at least one person. The method also includes receiving an indication from the user to tag the at least one person, the indication including an action to associate with the at least one person. The method also includes generating an audible description of the at least one person. The method also includes generating an audible description of the action. The method also includes broadcasting the audible description of the at least one person and the audible description of the action.

In one aspect, the method further includes tracking the at least one person that has been tagged and providing an update when an appearance of the at least one person that has been tagged has changed.

A system is provided. The system comprises a processor and a memory coupled to the processor. The memory contains thereon a set of instructions that when executed by the processor cause the processor to display, to a user, a video stream, the video stream including at least one person. The instructions further cause the processor to receive an indication from the user to tag the at least one person, the indication including an action to associate with the at least one person. The instructions further cause the processor to generate an audible description of the at least one person. The instructions further cause the processor to generate an audible description of the action. The instructions further cause the processor to broadcast the audible description of the at least one person and the audible description of the action.

In one aspect, the instructions on the memory further cause the processor to track the at least one person that has been tagged and provide an update when an appearance of the at least one person that has been tagged has changed.

A non-transitory processor readable medium containing a set of instructions thereon is provided. The instructions on the medium, when executed by a processor cause the processor to display, to a user, a video stream, the video stream including at least one person. The instructions on the medium further cause the processor to receive an indication from the user to tag the at least one person, the indication including an action to associate with the at least one person. The instructions on the medium further cause the processor to generate an audible description of the at least one person. The instructions on the medium further cause the processor to generate an audible description of the action. The instructions on the medium further cause the processor to broadcast the audible description of the at least one person and the audible description of the action.

In one aspect, the instructions on the medium further cause the processor to track the at least one person that has been tagged and provide an update when an appearance of the at least one person that has been tagged has changed.

In one aspect, the action is at least one of monitor and apprehend. In one aspect, the indication of the action is the user drawing a symbol on a screen displaying the video stream. In one aspect, the audible description of the at least one person includes a non-visual characteristic of the at least one person. In one aspect, the non-visual characteristic of the at least one person is at least one of armed and violent.

Further advantages and features consistent with this disclosure will be set forth in the following detailed description, with reference to the figures.

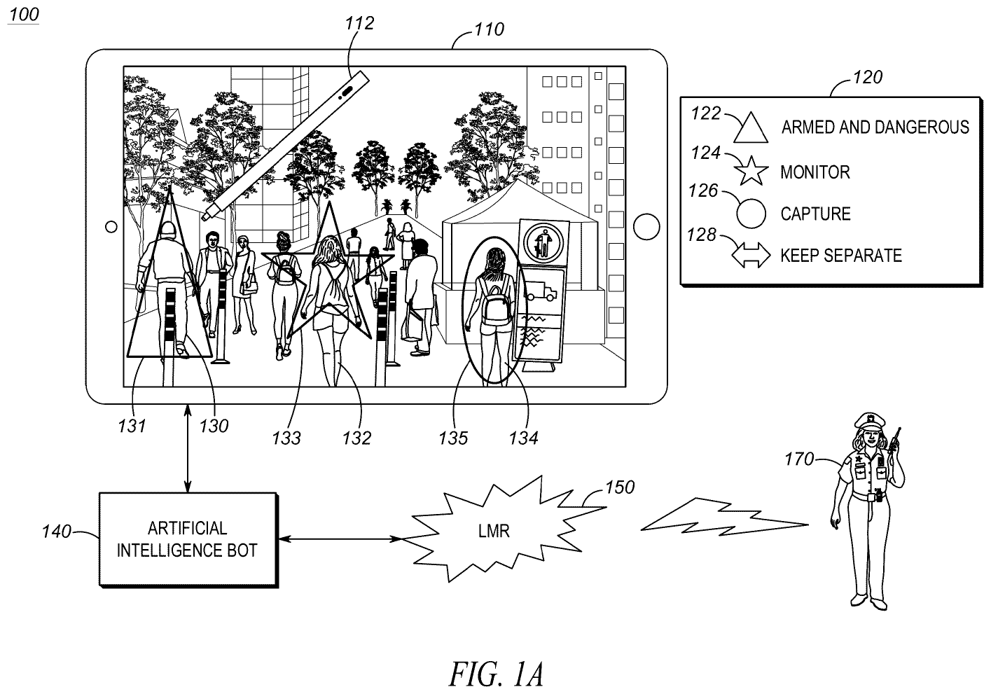

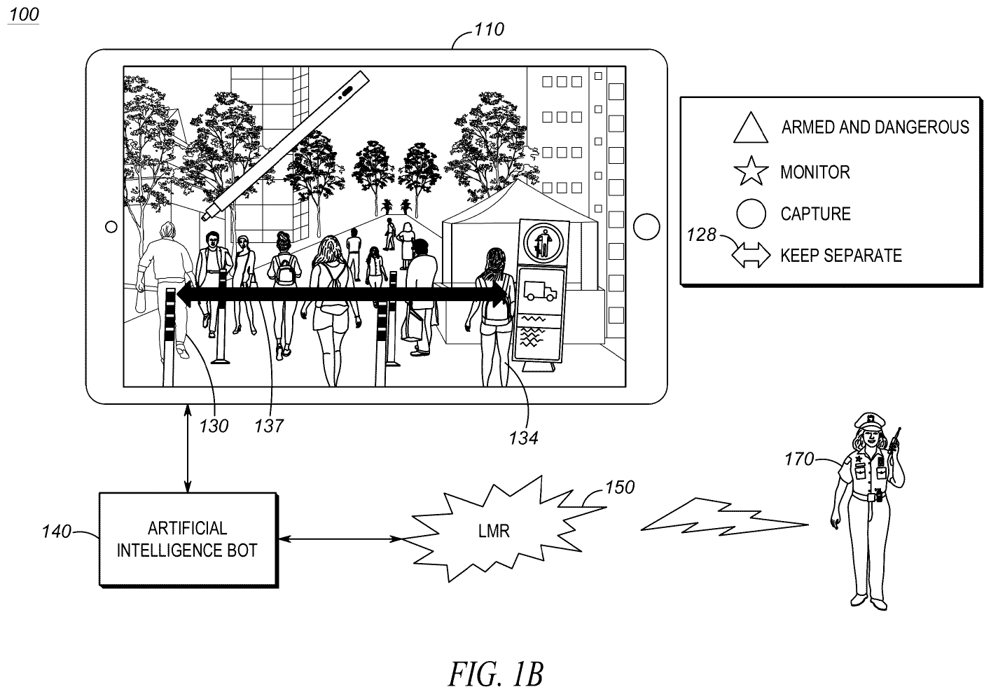

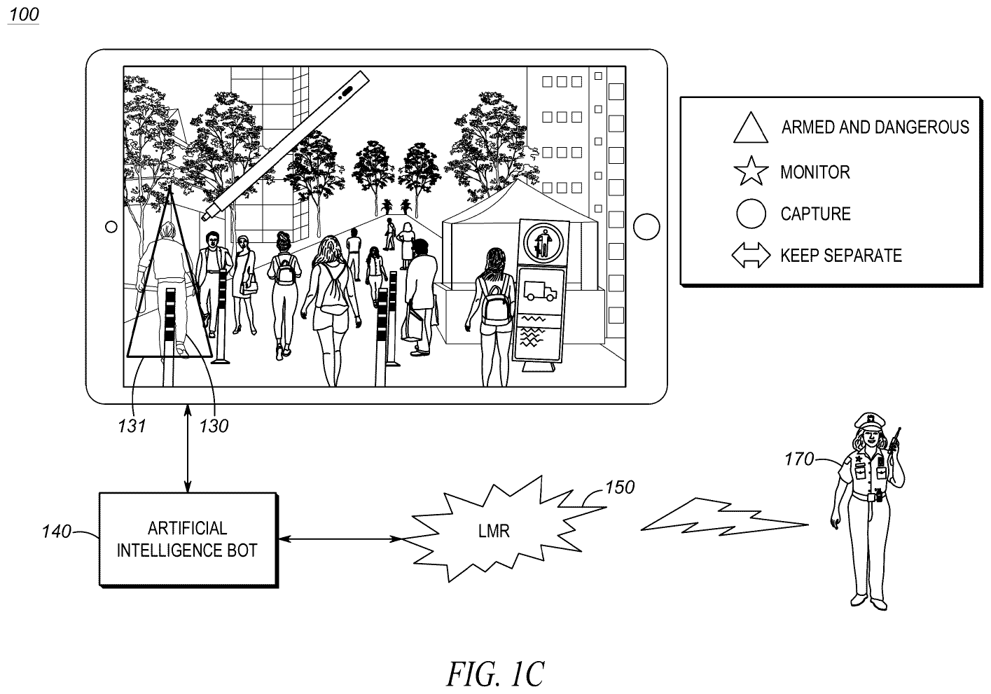

FIGS. 1A-C depict examples of tagging a person in a video with an action and to provide an audible description thereof according to the techniques described herein.

FIG. 1A depicts an example of an environment 100 which includes a display device 110, an AI bot 140, an LMR network 150, and a public safety officer equipped with an LMR device 170.

The display device 110 may be any type of device that is capable of displaying either video or still images. The remainder of this disclosure will refer to the use of video, however it should be understood that the techniques described herein are equally applicable to still video. Examples of display devices can include, but are not limited to, smartphones, tablets, laptop computers, desktop computers, dedicated purpose built display devices, or any other type of device that is capable of displaying video.

The display device 110 also includes an input mechanism 112 for allowing a user to indicate a person of interest appearing on the display. As will be described in further detail below, indicating a person of interest comprises drawing a shape with a defined meaning on top of the display device. As shown in FIG. 1, one example of an input device may be a stylus with which a user may draw the shape on top of a person of interest. For devices that include touch sensitive screens, a user's fingertip may be used to draw the shape on top of the person of interest. Other input devices can include a mouse, a trackpad, a trackpoint, a keyboard, etc. The particular form of input device is irrelevant. What should be understood is that any mechanism that allows a user to draw a shape on top of a person of interest shown in the display device would be suitable for use with the techniques described herein.

System 100 also includes an Artificial Intelligence (AI) bot 140. The AI bot may be trained on a training data set to provide descriptions of persons that appear on the display device 110. There are currently many available trained AI models that are available to perform an image to textual description function. For example, ChatGPT, Azure Vision services, etc. are examples of AI services that can receive an image and provide a description of what is contained in the image. The techniques described herein are not limited to any particular image to description AI service and are usable with any currently available or future developed AI bot providing such functionality. As will be described in further detail below, the image description will be focused on persons of interest within the video, as opposed to the overall contents of the video.

The environment 100 also includes an LMR network 150. The particular technology of the LMR network (e.g. P25, Tetra, etc.) is relatively unimportant. What should be understood is that the LMR network is designed for reliable voice communication and is not able to sustain transmission of video. Although an LMR network is mentioned, it should be understood that the techniques described herein are not so limited. What should be understood is that the network represents a network that is capable of transmitting voice to a receiver, but is not well suited to transferring high bandwidth data, such as video.

System 100 may also include a public safety first responder 170 that is equipped with a LMR radio. The public safety first responder is able to receive audio transmissions over the LMR radio. In some cases, the LMR radio may be a portable radio (e.g. a walkie talkie, etc.). In some cases, the LMR radio may be a mobile radio (e.g. mounted in a vehicle, etc.). The particular form of the radio is unimportant, and may not even be an LMR radio. What should be understood is that the device carried by the public safety first responder is capable of receiving audio, but is not necessarily capable of receiving higher bandwidth content, such as video.

In operation, a video may be displayed on display device 110. The source of the video is relatively unimportant. The video may come from public safety surveillance cameras. The video may come from private surveillance systems (e.g. enterprise systems, retail shopping, etc.). In some cases, the video may even come from private residences that have opted in to sharing video. What should be understood is that the techniques described herein are not limited to any particular source of video.

There may be a plurality of shapes associated with various actions and/or indications. For example, legend 120 may provide an indication of which shapes are associated with which actions/indications. For example, a triangle shape 122 may indicate that a person of interest should be considered armed and/or dangerous. A star shape 124 may indicate that the person of interest should be monitored only, as opposed to being detained. A circle 126 may indicate the person of interest should be captured. A double-headed arrow 128 may indicate two or more people should be kept separate. The keep separate action will be described in further detail with respect to FIG. 1B.

The display device 110 may display what is being captured by a camera. In the present example, the display is showing a scene with several pedestrians walking down a street. In this particular example, assume that there are three pedestrians of interest. For this example, assume that pedestrian 130 is a White male, blond hair, wearing a pink shirt, grey shorts, and a red baseball cap. Assume that pedestrian 132 is a Hispanic female, with brown hair, wearing an orange shirt, blue shorts, and is carrying a pink backpack. Assume that pedestrian 134 is an Asian female, with blond hair, wearing a brown shirt, red pants, and carrying a black purse.

A user of the system (e.g. RTCC analyst, Public Safety Commander, etc.) may wish to provide instructions to public safety first responder to take some action with respect to a person of interest. As explained above, the first responder may not have access to a device that can receive video and is only capable of receiving audio.

The user of the system may identify a person of interest by using the input mechanism 112 by drawing a shape on top of the person of interest. For example, assume that person 130 is to be considered armed and/or dangerous. The user may wish to convey this information to a first responder. The user uses the input mechanism to draw a triangle 131 on the person of interest on the display device. As described above, the triangle 122 is an indication that the person marked with such a shape may be armed and/or dangerous.

Upon the triangle shape 131 being drawn on person of interest 130, the AI bot 140 may provide a description of the person of interest 130. As mentioned above, techniques for using an AI bot to describe a person of interest once marked are known. The techniques described herein are not dependent on any specific implementation of generating a description for an identified person. As mentioned above, person 130 is a White male, blond hair, wearing a pink shirt, grey shorts, and a red baseball cap. The AI bot may generate this description. In some cases, initially the AI bot may generate the description in text. Known text to speech algorithms may then be used to convert the textual description to speech. In some implementations, the AI bot may directly generate audible speech.

The AI bot 140 may then send the action associated with the shape and the AI bot generated description to the first responder via LMR network 150. For example, the AI bot may generate audio, such as “The White male with blond hair who is wearing a pink shirt, grey shorts, and a red baseball cap should be considered armed and/or dangerous. ” This information is then transmitted via audio over the LMR network to the public safety first responder.

As yet another example, assume that person of interest 132 should be monitored (e.g. observed). The user simply uses the input mechanism 112 to draw a star shape 133, which is associated with the monitor action 124, on top of the person of interest 132 on the display device. The AI bot 140 may then generate a description, and send the information via audio, to the first responder 170. For example, the AI bot may generate the following sentence, “The Hispanic female, with brown hair, wearing an orange shirt, blue shorts, and carrying a pink backpack should be monitored” based on the description and the action associated with the shape. This sentence can then be sent as an audio transmission to the first responder over the LMR network 150.

As yet another example, person of interest 134 may need to be captured (e.g. arrested, detained, etc.). The user may use the input mechanism 112 to draw a circle 135 on the display device 110 over the person of interest 134. The circle 126 is associated with an action to capture the person of interest identified. Again, the AI bot 140 may generate the following sentence, “The Asian female, with blond hair, wearing a brown shirt, red pants, and carrying a black purse should be captured. ” As above, this sentence could be sent to the first responder 170 over the LMR network 150.

What should be understood is that the techniques described herein allow for the user to simply draw a shape on the person of interest without having to provide any additional input. From this simple action, a description of the person of interest is automatically generated by an AI bot in such a way that the description is not subject to human subjectivity (e.g. is the shirt red or orange?). Because the description is generated by an AI bot, it can be ensured that the descriptions will be consistent. Furthermore, the user is able to specify quickly what action is to be taken based on the shape chosen. It should also be understood that the information and/or action can be sent to the first responder 170 via audio, such that the first responder is not required to be equipped with a device capable of receiving video.

FIG. 1B depicts another type of action that can be indicated. One possible action may be indicated by a double-headed arrow and referred to as a keep separate action 128. In operation, the user may decide that two people within the field of view on the display device 110 should be kept at a distance. For example, one person may be the subject of a restraining order, and is not allowed within a specific distance of the other person.

The user may then draw the keep separate shape 128 between two people. For example, assume that person 130 should be kept separate from person 134. The user could draw the double headed arrow shape 137 between those two people. This would then cause the AI bot 140 to generate descriptions of each of the specified people and an indication that they should be kept separated. For example, the AI bot may generate the statement, “The White male with blond hair who is wearing a pink shirt, grey shorts, and a red baseball cap should be kept separate from the Asian female, with blond hair, wearing a brown shirt, red pants, and carrying a black purse. ” Just as above, this sentence can be audibly transmitted to the first responder 170 over the LMR network 150. Again, it should be noted that the only input required from the user is simply drawing the double headed arrow shape 137 on the display device.

Although specific actions have been describe with respect to FIG. 1A, B, it should be understood that the techniques described herein are not limited to those actions. Any other possible actions could be associated with a shape, and are equally useable with the techniques described herein. What should be understood is that a shape is associated with an action. Drawing the particular shape can indicate that the action should be applied to the person of interest upon which the shape was drawn.

FIG. 1C depicts another capability offered by system 100. Once a shape has been drawn on a person of interest, the AI bot 140 may continue to track the person of interest. If there is a change in the description of the person of interest, the AI bot may cause this change of appearance to be sent to the first responder 170 over the LMR network 150.

For example, in the description of FIG. 1A, a triangle 131 was drawn on person of interest 130 which caused the AI bot 140 to communicate to the first responder that, “The White male with blond hair who is wearing a pink shirt, grey shorts, and a red baseball cap should be considered armed and/or dangerous. ” The person of interest 130 may, at some point, cause his appearance to change. For example, the person of interest could remove the red baseball cap.

The AI bot 140, because it is tracking the person of interest 130, may then update the description. For example, the AI bot may generate the following sentence, “The White male with blond hair who is wearing a pink shirt, grey shorts, has now removed the red baseball cap, and should still be considered armed and/or dangerous. ” This sentence can then be audibly transmitted to the first responder 170 over the LMR network 150. What should be understood is that the user is relieved from the responsibility of continuously monitoring persons of interest to determine that their appearance has changed. Once the person of interest has been identified (e.g. by drawing the shape, etc.) any further changes in the description of the person of interest can be automatically conveyed, via audio, to the first responder.

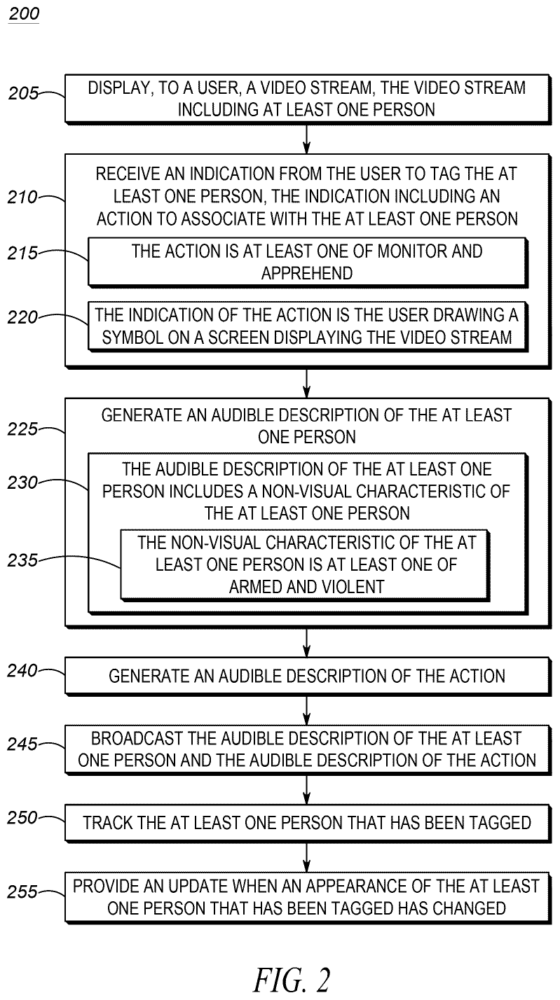

FIG. 2 is an example of a flow chart 200 that may represent an implementation of the tagging and audible description generation techniques described herein. In block 205, a video stream that includes at least one person is displayed to a user. As explained above the source of the video stream is relatively unimportant. The video stream may come from public or private cameras, surveillance cameras, enterprise cameras, etc. Any video stream generated by any type of cameras are suitable for use with the techniques described herein.

The video stream includes at least one person of interest. The video stream can include any number of other persons of interest or any number of persons not of interest. What should be understood is that at least one person of interest is included in the first video stream. The user is a user who wishes to convey information about the person of interest to a first responder who is not properly equipped to view the video stream directly. For example, the user maybe an analyst at a RTCC, a public safety supervisor/commander, etc. The particular role of the user is relatively unimportant. What should be understood is the user is able to view the video stream.

In block 210, an indication is received from the user to tag the at least one person. The indication includes an action to associate with the at least one person. The indication includes using an input device to indicate the action to associate with the at least one person. As described above, examples of actions can include to monitor the person, to capture the person, or to keep indicated persons separated.

In block 215, the action includes at least one of monitor and apprehend (e.g. capture). Although the techniques described herein are not limited to any specific action, in a public safety (e.g. law enforcement, etc.) context, monitoring a person of interest or capturing a person of interest are actions that are commonly performed. However, it should be understood that the techniques described herein are usable with any type of action, not just those explicitly mentioned.

In block 220, the indication of the action is the user drawing a symbol on a screen displaying the video stream. As explained above, the device used to view the video stream is equipped with an input mechanism (e.g. touch screen, stylus, mouse, etc.). The indication of the action may be provided by the user using any number of input mechanisms. The user may indicate the action by drawing a symbol (e.g. a shape) on the screen displaying the video stream using any available input mechanism. The symbol (e.g. shape, etc.) is associated with a specific action.

In block 225, an audible description of the at least one person is generated. As explained above, the person receiving the description (e.g. first responder, etc.) may be using a device that is not able to view video and is only capable of receiving audible transmissions. By generating the audible description, for example by using an AI bot, the user is relieved of the task of verbally describing the person of interest. The use of a function such as an AI bot can also eliminate subjectivity of descriptions of the person that would be present if the description were provided by different users.

In block 230, the audible description of the at least one person includes a non-visual characteristic of the at least one person. Although descriptions generally include visual characteristics of a person (e.g. sex, race, clothing, etc.) the techniques described herein are not so limited. For example, in block 235, the non-visual characteristic of the at least one person is at least one of armed and violent. In other words, the description of the person can include elements that cannot be determined by visual inspection. For example, the user may have knowledge of a person's proclivity for violence through other sources (e.g. law enforcement database, etc.) that would not be readily apparent from a visual examination.

In block 240, an audible description of the action is generated. As explained above, a receiver of the description may be equipped with a device that is only capable of receiving audio transmission. Thus, in order for the action described to be conveyed, it is first converted into an audible action. As described above every shape that can be drawn on the person of interest is associated with an action. Once the shape has been drawing, the corresponding action, and audible expression of that action is known.

In block 245, the audible description of the at least one person and the audible description of the action is broadcast. For example, the audible information may be broadcast to a first responder who is equipped with a device that is only capable of receiving audio transmission. The broadcast may be received by the first responder to execute the action with respect to the at least one person.

In block 250, the at least one person that has been tagged is tracked. For example, the AI bot can continue to monitor the at least one person. For example, the at least one person can continue to be monitored to determine if the appearance (e.g. description, etc.) of the at least one person has changed. For example, if the at least one person has added/removed a piece of clothing, this would indicate a change in the description of the at least one person.

In block 255, an update is provided when an appearance of the at least one person that has been tagged has changed. When a change in appearance is detected via the tracking, an audible description of the change in description can be generated. This audible description of the change in appearance may then be communicated via audio, to a receiver who is only equipped to receive audio.

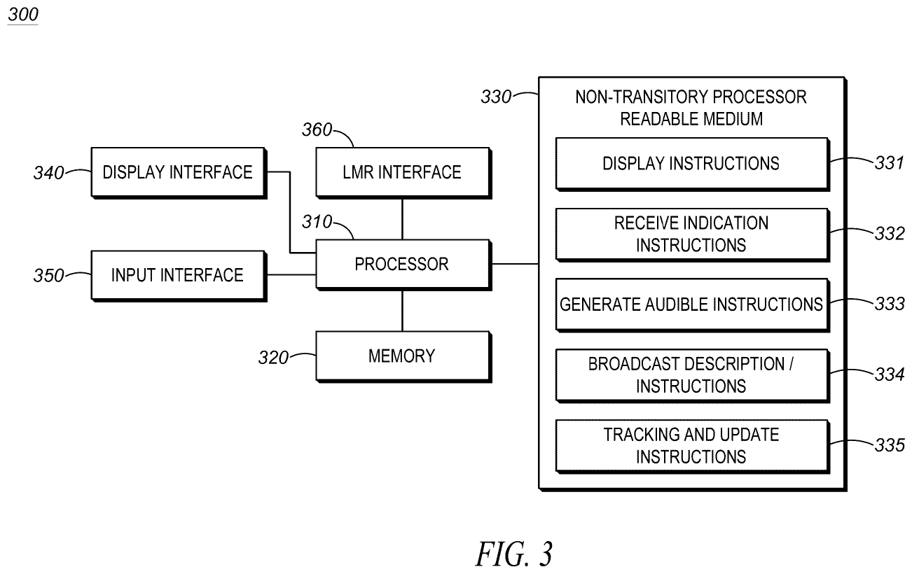

FIG. 3 is an example of a device 300 that may implement the tagging and audible description techniques described herein. It should be understood that FIG. 3 represents one example implementation of a computing device that utilizes the techniques described herein. Although only a single processor is shown, it would be readily understood that a person of skill in the art would recognize that distributed implementations are also possible. For example, the various pieces of functionality described above (e.g. tagging, audible description generation, etc.) could be implemented on multiple devices that are communicatively coupled. FIG. 3 is not intended to imply that all the functionality described above must be implemented on a single device.

Device 300 may include processor 310, memory 320, non-transitory processor readable medium 330, display interface 340, input interface 350, and LMR interface 360.

Processor 310 may be coupled to memory 320. Memory 320 may store a set of instructions that when executed by processor 310 cause processor 310 to implement the techniques described herein. Processor 310 may cause memory 320 to load a set of processor executable instructions from non-transitory processor readable medium 330. Non-transitory processor readable medium 330 may contain a set of instructions thereon that when executed by processor 310 cause the processor to implement the various techniques described herein.

For example, medium 330 may include display instructions 331. The display instructions 331 may cause the processor to display the video feed from a camera to a display device using display interface 340. For example, the display device could be a smartphone, laptop, or any other such device. The display interface may be used to cause a video stream to appear on the display device. The display instructions 331 are described throughout this description generally, including places such as the description of block

The monitor customer instructions 331 may cause the processor to monitor a customer as they interact with the physical retail store. For example, the processor may utilize the video systems interface 350 to access video systems within the physical retail store to determine if the customer is currently in areas where intangible transactions are expected to occur. The monitor customer instructions 331 are described throughout this description generally, including places such as the description of block 205.

The medium 330 may include receive indication instructions 332. The receive indication instructions 332 may cause the processor to receive, from the user, an indication of at least one person in the video stream who should be associated with an action. For example, the processor may utilize the input interface 350, which is associated with an input mechanism (e.g. touch input, stylus input, mouse input, etc.) to receive an indication of the person and the action. The receive indication instructions 332 are described throughout this description generally, including places such as the description of blocks 210-220.

The medium 330 may include generate audible instructions 333. The generate audible instructions 333 may cause the processor to generate an audible description of the at least one person as well as an audible description of the action. In some cases, the generate audible instructions 333 may implement an AI bot that is used to generate the audible description. The generate audible instructions 333 are described throughout this description generally, including places such as the description of blocks 225-240.

The medium 330 may include broadcast description instructions 334. The broadcast description instructions 334 may cause the processor to utilize the LMR interface 360 to broadcast the generated audible descriptions to a first responder equipped with a device that is cable of receiving audio transmissions. The broadcast description instructions 334 are described throughout this description generally, including places such as the description of block 245.

The medium 330 may include tracking and update instructions 335. The tracking and update instructions 335 may cause the processor to continuously track the at least one person to detect changes in the description of the at least one person. Upon detection of a change, the tracking and update instructions 335 may cause the processor to cause a new description to be generated and sent, via the LMR interface 360, to the first responder. The tracking and update instructions 335 are described throughout this description generally, including places such as the description of blocks 250 and 255.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps. ”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot receive a tag input via a touchscreen and generate an audible description of the tag object and action, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more. ” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
displaying, to a user, a video stream, the video stream including at least one person;
receiving an indication from the user to tag the at least one person, the indication including an action to associate with the at least one person;
generating an audible description of the at least one person;
generating an audible description of the action; and
broadcasting the audible description of the at least one person and the audible description of the action.

2. The method of claim 1 wherein the action is at least one of monitor and apprehend.

3. The method of claim 1 wherein the indication of the action is the user drawing a symbol on a screen displaying the video stream.

4. The method of claim 1 further comprising:
tracking the at least one person that has been tagged; and
providing an update when an appearance of the at least one person that has been tagged has changed.

5. The method of claim 1 wherein the audible description of the at least one person includes a non-visual characteristic of the at least one person.

6. The method of claim 5 wherein the non-visual characteristic of the at least one person is at least one of armed and violent.

7. A system comprising:
a processor; and
a memory coupled to the processor, the memory containing a set of instructions thereon that when executed by the processor cause the processor to:
display, to a user, a video stream, the video stream including at least one person;
receive an indication from the user to tag the at least one person, the indication including an action to associate with the at least one person;
generate an audible description of the at least one person;
generate an audible description of the action; and
broadcast the audible description of the at least one person and the audible description of the action.

8. The system of claim 7 wherein the action is at least one of monitor and apprehend.

9. The system of claim 7 wherein the indication of the action is the user drawing a symbol on a screen displaying the video stream.

10. The system of claim 7 further comprising instructions that cause the processor to:
track the at least one person that has been tagged; and
provide an update when an appearance of the at least one person that has been tagged has changed.

11. The system of claim 7 wherein the audible description of the at least one person includes a non-visual characteristic of the at least one person.

12. The system of claim 11 wherein the non-visual characteristic of the at least one person is at least one of armed and violent.

13. A non-transitory processor readable medium containing a set of instructions thereon that when executed by a processor cause the processor to:
display, to a user, a video stream, the video stream including at least one person;
receive an indication from the user to tag the at least one person, the indication including an action to associate with the at least one person;
generate an audible description of the at least one person;
generate an audible description of the action; and
broadcast the audible description of the at least one person and the audible description of the action.

14. The medium of claim 13 wherein the action is at least one of monitor and apprehend.

15. The medium of claim 13 wherein the indication of the action is the user drawing a symbol on a screen displaying the video stream.

16. The medium of claim 13 further comprising instructions that cause the processor to:
track the at least one person that has been tagged; and
provide an update when an appearance of the at least one person that has been tagged has changed.

17. The medium of claim 13 wherein the audible description of the at least one person includes a non-visual characteristic of the at least one person.

18. The medium of claim 17 wherein the non-visual characteristic of the at least one person is at least one of armed and violent.
